(19) United States
(12) Patent Application Publication
(10) Pub. No.: US 2025/0021414 A1
(43) Pub. Date: Jan. 16, 2025

(54) UNIFIED REST API FOR GRAPHIC DESIGN SYSTEM

(71) Applicant: Figma, Inc., San Francisco, CA (US)

(72) Inventors: James Yang, San Francisco, CA (US); Grace Lin, San Francisco, CA (US); Bersabel Tadesse, San Francisco, CA (US); Karl Jiang, San Francisco, CA (US)

(21) Appl. No.: 18/750,279

(22) Filed: Jun. 21, 2024

Related U.S. Application Data
(60) Provisional application No. 63/522,405, filed on Jun. 21, 2023.

(51) Int. Cl. G06F 9/54

(52) U.S. Cl. CPC G06F 9/547

(57) ABSTRACT

An interactive graphic design system implements a single unified application programming interface to remotely add and update variables associated with a graphic design file. The interactive graphic design system receives an API request from a programmatic process executed on a remote device, the API request including one or more lists of key/value pairs. The interactive graphic design system accesses the graphic design file and edits the variables in the graphic design file based on the one or more lists of key/value pairs included in the API request. Upon determining that a new variable specified in the API request does not exist in the graphic design file, the interactive graphic design system adds the new variable with a new identifier to the graphic design file and provides the new identifier to the remote device in a response to the API request.

### RELATED APPLICATIONS

This application claims benefit of priority to provisional U.S. patent application No. 63/522,405, filed Jun. 21, 2023; the aforementioned priority application being hereby incorporated by reference in its entirety.

### TECHNICAL FIELD

Examples described herein relate to a graphic design system, and more specifically, a unified rest API for a graphic design system.

### BACKGROUND

Software design tools have many forms and applications. In the realm of application user interfaces, for example, software design tools require designers to blend functional aspects of a program with aesthetics and even legal requirements, resulting in a collection of pages which form the user interface of an application. For a given application, designers often have many objectives and requirements that are difficult to track.

### BRIEF DESCRIPTION OF THE DRAWINGS

FIG. 1 illustrates an interactive graphic design system, according to one or more examples.

FIG. 2 illustrates a method of using a graphic design system unified REST API, according to one or more examples.

FIG. 3 illustrates a computer system on which one or more embodiments can be implemented.

FIG. 4 illustrates a user computing device for use with one or more examples, as described.

### DETAILED DESCRIPTION

In examples, a computing system is configured to implement an interactive graphic design system or platform for enabling users to create various types of content, including graphic designs, whiteboards, presentations, web pages, etc. As described with examples, an interactive graphic design system can be implemented to include a Representational State Transfer Application Programming (REST) API to extend the functionality and/or accessibility of the system.

Among other advantages, examples provide for an interactive graphic design system that implements a unified REST API to support workflows for designers and developers, as well as enterprises which utilize large teams of collaborators and developers. The use of REST API enables an enterprise or other organization to uniformly update data sets that define variables and best practices for its enterprise users and teams. Examples as described also support developer workflows, such as in the case of a developer merging changes to their code system in a third-party code repository (e.g., GitHub) and having that update corresponding variables in the design files stored with a network service through a REST API endpoint.

One challenge for organizations integrating with such an endpoint is knowing whether a variable is a new or has already been added to their design file on the network service. When these variables are first added to their design file on the network service, the service can detect they are brand new and does not have to be concerned about any existing variables or accidentally adding duplicates. However, syncing subsequent changes requires the service to figure out the identifiers of existing variables that have already been added because the PUT endpoint requires IDs. If this is not done and a POST call is subsequently made, then design file on the network service may end up with duplicate variables and variable collections.

One approach is to update an original program file (e.g., JSON file) that can be used with a graphic design system to include IDs. The absence of an ID in a variable indicates that it is brand new and needs to be added. In addition, the new IDs are added to the variables based on API responses from the graphic design network service. However, it can be difficult to do this if the synchronization process is automated.

In another approach, the graphic design network service can implement additional logic to map design variables to variables in the original program file (e.g., JSON file) by name. This can work as long as variable and variable collection names are unique. However, renaming variables may be difficult because a renamed variable looks just like a new variable.

Embodiments as described provide an alternative approach of utilizing REST APIs to add and update variables for an interactive graphic design system, thereby avoiding the pitfalls associated with other approaches. In embodiments, an interactive graphic design system implements a single unified application programming interface (API) to remotely add and update variables associated with a graphic design file. The interactive graphic design system receives an API request from a programmatic process executed on a remote device, the API request including one or more lists of key/value pairs. The interactive graphic design system accesses the graphic design file and edits the variables in the graphic design file based on the one or more lists of key/value pairs included in the API request. Upon determining that a new variable specified in the API request does not exist in the graphic design file, the interactive graphic design system adds the new variable with a new identifier to the graphic design file and provides the new identifier to the remote device in a response to the API request.

In some aspects, the API request is used to synchronize at least some of the variables in the graphic design file with a network service on the remote device. The keys in the key/value pairs can include actions, variable identifiers, names, collection identifiers, data types, etc. If no value is specified with the API request, the interactive graphic design system can apply default variable values consistent with a variables table interface to the new variable.

Furthermore, the API request includes an authentication token for an organization with access to the graphic design file, and accessing the graphic file includes using the authentication token to permit access. Editing the variables in the graphic design file is treated as an atomic operation such that if there are any validation failures, then the graphic design file remains unchanged.

In additional examples, a graphic design system implements a REST API to integrate data sets used by third-party services, to manage workflows with regards to user's participation with the graphic design system, and to manage configurations can be used to create extensions and integrations in other products that communicate with the graphic design system's platform/service over a network.

Among other advantages, the graphic design system can include a REST API to enable users to automate certain aspects of project management for their design workflows. For example, a graphic design can be created and updated through the graphic design system, while at the same time, portions of the graphic design are published on a third-party service using a REST API. Further, the graphic design can be continuously updated by collaborators, working on the graphic design through the graphic design system, while the graphic design is published with the third-party service. The graphic design, as published by the third-party service, can also be updated to reflect changes made by collaborators.

In additional examples, the graphic design system is configured to implement a REST API to select data sets, generated in connection with a team of users collaborating on a graphic design, with a third-party service or site. For example, users who collaborate on a graphic design can generate interactive comments to exchange messages and communicate with one another. The comments form an additional layer of data, where the data is separate but integrated (e.g., as overlay content) with the graphic design. In such examples, the REST API is used to share a data set, corresponding to comments and/or communications exchanged by collaborators while working on the graphic design, with a third-party service.

In examples, the IGDS can be implemented with the REST API to link to graphic design files from within other products. In additional examples, an interactive graphic design system can use the REST API to create custom, rich previews of graphic design files in third-party services, and to utilize extensible aspects of third-party services.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, a software component, or a hardware component capable of performing one or more stated tasks or functions. As used herein, a module or component can exist on a hardware component independently of other modules or components. Alternatively, a module or component can be a shared element or process of other modules, programs, or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more aspects described herein may be implemented through the use of instructions that are executable by one or more processors. These instructions may be stored on a computer-readable medium. Machines shown or described with figures below provide examples of processing resources and computer-readable media on which instructions for implementing some aspects can be stored and/or executed. In particular, the numerous machines shown or described include processors and various forms of memory for storing data and instructions. Examples of computer-readable media include permanent memory storage devices, such as hard disk drives on personal computers or servers. Other examples of computer storage media include portable storage units, such as CD or DVD units, flash or solid-state memory (such as carried on cell phones, tablets, and other consumer electronic devices), and magnetic memory. Computers, terminals, and network-enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions, and processing is performed by interconnected gates.

### System Description

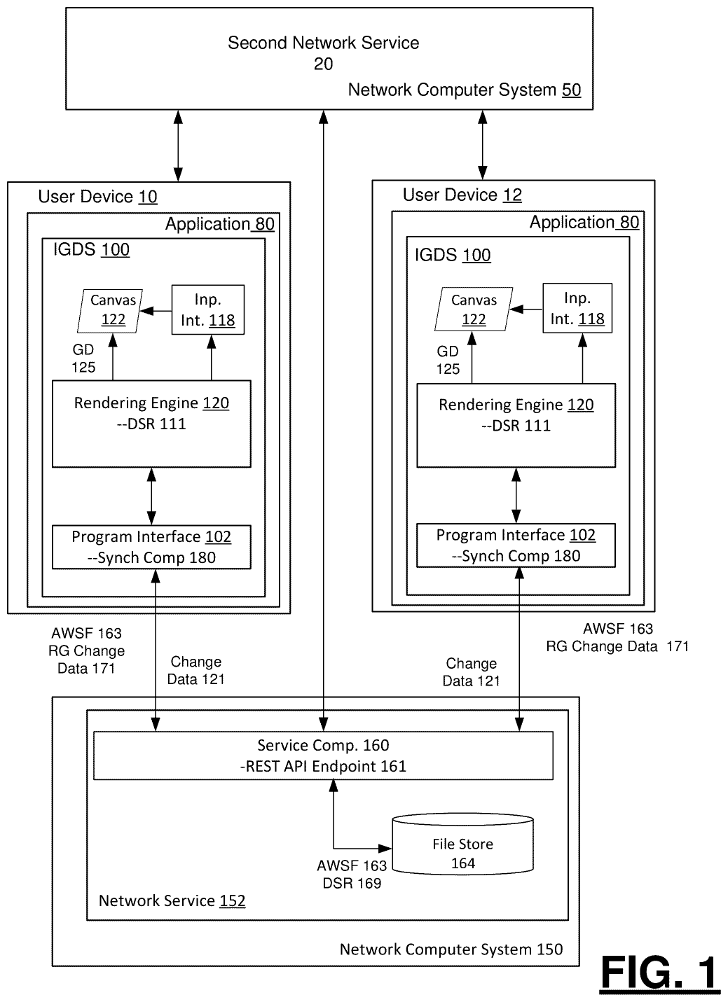

FIG. 1 illustrates an interactive graphic design system for a computing device of a user, according to one or more examples. An interactive graphic design system (“IGDS”) 100 can be implemented in any one of multiple different computing environments. The IGDS 100 can be implemented in-part using a web-based application that executes on individual user computing devices 10, 12 to provide functionality as described with various examples. Further, the IGDS 100 can be implemented in-part using a network computing system 150. In other examples, such as described below, the IGDS 100 can be implemented through use of a web-based application 80. The web-based application 80 can execute scripts, code and/or other logic (the “programmatic components”) to implement functionality of the IGDS 100. Additionally, in some variations, the IGDS 100 can be implemented as part of a network service, where web-based application 80 communicates with one or more remote computers (e.g., server used for a network service) to executes processes of the IGDS 100. As an addition or alternative, the IGDS 100 can be implemented as a distributed system, such that processes described with various examples execute on individual user devices 10, 12, in combination with one or more network computers 150 that provide a corresponding first network service 152 (e.g., represented by network computer system 150).

In variations, the IGDS 100 can also be integrated with a second network service that is implemented separate or independent of the first network system 150. In such cases, the user devices 10, 12 can access the network service 152 through a second network service 20 operating on a second network computer system 50. Such user devices 10, 12 that access the network service 152 through the second service 20 can initiate a remote session with the network computer system 150, using an application program interface (e.g., REST API) provided by the second network computer system 50. For remote sessions, the network computer system 150 for the first network service can be deemed external from the network computer system for the second network service, meaning that the network computer systems are independently managed, and provided through different domains and/or entities. In examples, the second network service 20 can provide functionality corresponding to, for example, a productivity application (e.g., an application to maintain records of different types, manage and automate workflows and processes that use the records, render contents of the records in a particular format, transmit and synchronize records amongst different data sets, etc.) or a communication platform (e.g., exchange messages in real-time, enable video communication exchanges, exchange of files, etc.).

The network computing system 150 can include an endpoint of a REST API 161. On a user device 10, 12 where a remote session is initiated, the web-based application 80 can integrate with the IGDS 100 in connection with receiving a second network service 20 from an external network computer system 50. Furthermore, in examples, the IGDS 100 can enable a collaborative network platform, to enable collaboration by multiple users operating respective computing devices 10, 12 to collaborate on a graphic design. The user computing devices 10, 12 can be assumed as being operated by users that are associated with a common organization, with each user computing device 10, 12 implementing a corresponding IGDS 100 to access the same workspace during respective sessions that overlap with one another.

In some examples, web-based application 80 retrieves some or all of the programmatic resources for implementing the IGDS 100 from a network site. As an addition or alternative, web-based application 80 can retrieve some or all of the programmatic resources from a local source (e.g., local memory residing with the computing device 10). The web-based application 80 may also access various types of data sets in providing the IGDS 100. The data sets can correspond to files and libraries, which can be stored remotely (e.g., on a server, in association with an account) or locally.

In examples, the web-based application 80 can correspond to a commercially available browser, such as GOOGLE CHROME (developed by GOOGLE, INC.), SAFARI (developed by APPLE, INC.), and EDGE (developed by the MICROSOFT CORPORATION).

In some examples, the processes of the IGDS 100 can be implemented as scripts and/or other embedded code which web-based application 80 downloads from a network site. For example, the web-based application 80 can execute code that is embedded within a webpage to implement processes of the IGDS 100. The web-based application 80 can also execute the scripts to retrieve other scripts and programmatic resources (e.g., libraries) from the network site and/or other local or remote locations. By way of example, the web-based application 80 may execute JavaScript embedded in an HTML resource (e.g., webpage structured in accordance with HTML 5.0 or other versions, as provided under standards published by W3C or WHATWG consortiums). In some examples, the rendering engine 120 and/or other components may utilize graphics processing unit (GPU) accelerated logic, such as provided through WebGL (Web Graphics Library) programs which execute Graphics Library Shader Language (GLSL) programs that execute on GPUs.

According to examples, user of computing device 10 operates web-based application 80 to access a network site, where programmatic resources are retrieved and executed to implement the IGDS 100. In this way, the user may initiate a session to implement the IGDS 100 for purpose of creating and/or editing a design interface. In examples, the IGDS 100 includes a program interface 102, an input interface 118, and a rendering engine 120. The program interface 102 can include one or more processes which execute to access and retrieve programmatic resources from local and/or remote sources.

In an implementation, the program interface 102 can generate, for example, a canvas 122, using programmatic resources which are associated with web-based application 80 (e.g., HTML 5.0 canvas). As an addition or variation, the program interface 102 can trigger or otherwise cause the canvas 122 to be generated using programmatic resources and data sets (e.g., canvas parameters) which are retrieved from local (e.g., memory) or remote sources (e.g., from network service).

The program interface 102 may also retrieve programmatic resources that include an application framework for use with canvas 122. The application framework can include data sets which define or configure, for example, a set of interactive graphic tools that integrate with the canvas 122 and which comprise the input interface 118, to enable the user to provide input for creating and/or editing a design interface.

According to some examples, the input interface 118 can be implemented as a functional layer that is integrated with the canvas 122 to detect and interpret user input. The input interface 118 can, for example, use a reference of the canvas 122 to identify a screen location of a user input (e.g., ‘click’). Additionally, the input interface 118 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In this manner, the input interface 118 can interpret, for example, a series of inputs as a design tool selection (e.g., shape selection based on location of input), as well as inputs to define attributes (e.g., dimensions) of a selected shape.

Additionally, the program interface 102 can be used to retrieve, from local or remote sources, programmatic resources and data sets which include files 163 which comprise an active workspace for the user. The workspace files 163 can be retrieved from a file store 164, and the files 163 include data sets that represent the graphic design 125, as well as additional data sets that are generated for use with the graphic design system (e.g., comments, annotations, etc.). The retrieved data sets can include one or more pages that include design elements which collectively form a design interface, or a design interface that is in progress. Each file 163 can include one or multiple data structure representations 111 which collectively define the design interface. The files 163 may also include additional data sets which are associated with the active workspace, such as files containing the comments or annotations, which may be integrated with the rendering of a graphic design.

In examples, the rendering engine 120 uses the data structure representations 111 to render a corresponding graphic design 125 on the canvas 122, wherein the graphic design 125 reflects graphic elements and their respective attributes as provided with the individual pages of the files 101. The user can edit the graphic design 125 using the input interface 118. Alternatively, the rendering engine 120 can generate a blank page for the canvas 122, and the user can use the input interface 118 to generate the graphic design 125. As rendered, the graphic design 125 can include graphic elements such as a background and/or a set of objects (e.g., shapes, text, images, programmatic elements), as well as attributes of the individual graphic elements. Each attribute of a graphic element can include an attribute type and an attribute value. For an object, the types of attributes include, shape, dimension (or size), layer, type, color, line thickness, text size, text color, font, and/or other visual characteristics. Depending on implementation, the attributes reflect properties of two- or three-dimensional designs. In this way, attribute values of individual objects can define, for example, visual characteristics of size, color, positioning, layering, and content, for elements that are rendered as part of the graphic design 125.

When implemented as a collaborative platform, the network computing system 150 communicates with multiple user computing devices 10, 12 over one or more networks (e.g., World Wide Web) to implement the IGDS 100 on each of the collaborating computing device 10, 12. Accordingly, each of the user computing devices 10, 12 may access the same set of active workspace files 163 at the same time, with the respective program interface 102 of the IGDS 100 on each user computing device 10, 12 operating to establish a corresponding communication channel (e.g., web socket connection) with the service component 160. Each of the computing devices 10, 12 can maintain a local data structure representation 111 of the respective graphic design 125, as determined from the active workspace files 163. The service component 160 can also maintain a network-side data structure representation 169 obtained from the files of the active workspace 163 and coinciding with the local data structure representations 111 on each of the computing devices 10, 12.

When the IGDS 100 is implemented as a collaborative platform, the user computing devices 10, 12 can be assumed as being operated by users that are associated with a common account, with each user computing device 10, 12 implementing a corresponding IGDS 100 to access the same workspace during respective sessions that overlap with one another. Accordingly, each of the user computing devices 10, 12 may access the same set of active workspace files 163 at the same time, with the respective program interface 102 of the IGDS 100 on each user computing device 10, 12 operating to establish a corresponding communication channel (e.g., web socket connection) with the service component 160.

The network computing system 150 can continuously synchronize the active workspace files 163 on each of the user computing devices 10, 12. In particular, changes made by users to the graphic design 125 on one computing device 10, 12 may be immediately reflected on the graphic design 125 rendered on the other user computing device 10, 12. By way of example, the user of computing devices 10 can make a change to the respective graphic design 125, and the respective rendering engine 120 can implement an update that is reflected in the local copy of the data structure representation 111. From the computing device 10, the program interface 102 of the IGDS 100 can stream change data 121, reflecting the change of the user input, to the service component 160. The service component 160 processes the change data 121 of the user computing device. The service component 160 can use the change data 121 to make a corresponding change to the network-side data structure representation 161. The service component 160 can also stream remotely generated change data 171 (which in the example provided, corresponds or reflects change data 121 received from the user device 10) to the user device 12, to cause the corresponding IGDS 100 to update the local workspace files 163 on the respective user devices 10, 12, meaning each of the collaborators have a consistent view of the graphic design 125. The user device 12 may also use the remotely generated change data 171 to update the local data structure representation 111 of that user device 12. The program interface 102 of the user device 12 can receive the update from the network computing system 150, and the rendering engine 120 can update the graphic design 125 and the respective local copy of 111 of the user device 12.

The reverse process can also be implemented to update the data structure representations 169 of the network computing system 150 using change data 121 communicated from the second user device 12 (e.g., corresponding to the user of the second computing device updating the graphic design 125 as rendered on the second user device 12). In turn, the network computing system 150 can stream remotely generated change data 171 (which in the example provided, corresponds or reflects change data 121 received from the user device 12) to update the local data structure representation 111 of the graphic design 125 on the first computing device 10. In this way, the graphic design 125 of the first computing device 10 can be updated as a response to the user of the second user device 12 providing user input to change the graphic design 125.

To facilitate the synchronization of the data structure representations 111, 111 on the computing devices 10, 12, the network computing system 150 may implement a stream connector to merge the data streams which are exchanged between the first computing device 10 and the network computing system 150, and between the second user device 12 and the network computing system 150. In some implementations, the stream connector can be implemented to enable each computing device 10, 12 to make changes to the network-side data representation 169, without added data replication that may otherwise be required to process the streams from each device separately.

Additionally, over time, one or both of the computing devices 10, 12 may become out-of-sync with the server-side data representation 169. In such cases, the respective computing device 10, 12 can redownload the active workspace files 163, to restart the maintenance of the data structure representation of the graphic design 125 that is rendered and edited on that device.

### Remote Session

Any of the user computing devices 10, 12 can initiate (“initiating user”) a remote session with the network service 152 (for implementing the IGDS in an embedded fashion). As described with some examples, the remote session corresponds to one where the collaborating user accesses the network service 152 via an API provided through a second network service (e.g., productivity service, communication service, developer service, etc.). On a computing device 10, 12 where a remote session is initiated, the IGDS 100 retrieves and executes an instance of the web-resources, including a data structure representation 111 of the graphic design 125. The data structure representation 111 can reflect the most updated state of the graphic design, where at least some collaborators include users that access workspace files and other data sets for a graphic design via the REST API. The most recent state of the graphic design 125 can be represented by the network-side data representation 169.

To implement a remote session, the IGDS 100 implements a synchronization component 180 that executes on the respective user device 10, 12 to trigger a synchronization operation. The synchronization operation can request, from the network service 152, change data 121 from the network side representation 169 of the design interface. If change data 121 is received, the synchronization component 180 updates the local data representation 111 on the respective user device 10, 12. While a remote session is active, the synchronization component 180 on each user device 10, 12 can repeatedly request change data 121 for the active graphic design 125. Further, if a user performs an operation that updates the graphic design 125, the synchronization component 180 updates the local data structure 111 on the user computing device 10, 12, and the synchronization component 180 sends change data 111 from the user device 10, 12 to the network service 152. In turn, the network service 152 updates the network representation of the graphic design and transmits corresponding change data 121 to user computing devices 10, 12 of collaborators. If any collaborator devices 10, 12 are implementing the IGDS 100 as a remote session, some examples provide for the synchronization component 180 of those devices to access (e.g., request via the REST API) and implement the change data 121 from the network service 150.

On devices 10, 12 where a remote session with the network service 152 is implemented, the graphic design 125 (and/or the data representation 111), or portions thereof, can be used by the second network service. The rendering engine 120 can render, for example, the graphic design 125 user device 10, 12 can render the graphic design in context of, for example, application functionality provided by the second network service. Further, in some examples, through use of the second network service, changes may be made to the graphic design 125. The changes can be reflected in the data representation 111 of the user device 10, 12 where the remote session occurs. The synchronization component can synchronize the data representation 111 with the network service 152, where the network representation 169 is updated.

Further, in some examples, when other collaborators make changes to the graphic design 125, the changes can be received on the user device 10, 12 where the remote session occurs. On that user device, the data representation 111 of the graphic design can be changed, and the rendering engine 120 can update the rendering of the graphic design 125 on those devices 10, 12. In turn, the update may be reflected through a workflow or rendering of the graphic design 125 with the second network service.

In some examples, the REST API endpoint 161 can be used for creating and updating component links and variables, which allows teams to better sync their design systems between the network service 152 and the second network service 20. The REST API endpoint 161 can also offer functionality for duplicating a file given a file key to improve workflow automation. This API supports workflows such as creating a design file from a template when a task is moved to a particular section within the second network service 20.

The REST API Endpoint 161 supports POST operations that enable the second network service 20 to create, update, and delete variables and variable collections in a unified endpoint. The POST request body has flattened variableCollections, variables, variableModes, and variableModeValues lists at the top level. Any of these lists are optional. There is no nesting, which makes it easier to update a variable or variable value given IDs. When adding new modes or variables, default variable values consistent with the variables table UI are applied. Furthermore, everything to be added/updated is treated as one atomic operation. If there is any validation failure, then the network service 152 does not persist any changes.

In some examples, the REST API endpoint 161 can support a few different types of tokens for authentication. Since one of the core use cases for the REST API endpoint 161 is being able to sync variables from another source of truth into the network service 152, relying on tokens tied to individual users can be problematic (the sync will break if the individual leaves the company or happens to lose access to the file). Accordingly, requests to the REST API endpoint 161 should include an authentication token for an organization with access to the graphic design file.

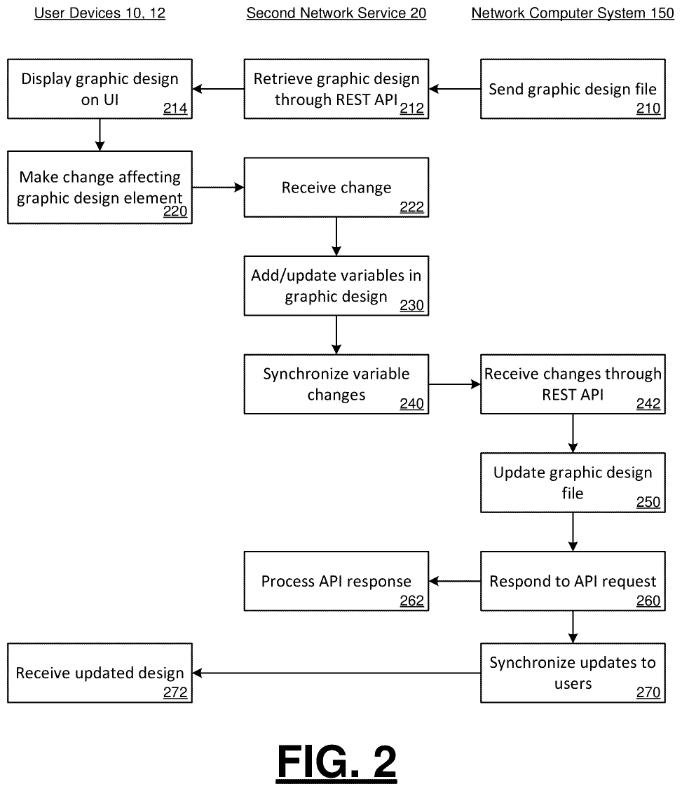

FIG. 2 illustrates a method of using a graphic design system unified REST API. While operations of the method are described below as being performed by specific components, modules, or systems of the network computer system 150, it will be appreciated that these operations need not necessarily be performed by the specific components identified and could be performed by a variety of components and modules, potentially distributed over a number of machines. Accordingly, references may be made to elements of the network computer system 150 for the purpose of illustrating suitable components or elements for performing a step or sub step being described. Alternatively, at least certain ones of the variety of components and modules described in the network computer system 150 can be arranged within a single hardware, software, or firmware component. It will also be appreciated that some of the steps of this method may be performed in parallel or in a different order than illustrated.

In some aspects, the network computer system 150 sends a graphic design file or parts of a file to a second network service 20, such as a third-party code repository, workflow automation tool, etc. (210). This transmission can occur as a response to a request made by the second network service 20 to a REST API endpoint on the network computer system 150 (212). The second network service 20 can then process the graphic design file according to its built-in functionality or plugin functionality to provide a display of some aspects of the graphic design on a user interface of one or more user devices 10, 12 (214).

In some aspects, a user of one of the user devices 10, 12 makes a change through the UI of their device which affects one or more graphic design elements in the graphic design file (220). For example, the user may edit part of the design itself to add a new object or change the properties of an existing object. As another example, the user may write a function associated with an element on the graphic design without modifying the design itself. In response to the change, the user device 10, 12 sends the change to the second network service 20 over a network (222).

Based on the received change, the second network service 20 adds or updates new variables in the graphic design (230). The second network service 20 then synchronizes the variable changes with the network computer system 150 (240). For example, the second network service 20 may use an authentication token provided by the user to make a POST request to the REST API endpoint on the network computer system 150 (242).

In some aspects, the network computer system 150 receives the changes through the REST API and updates the graphic design file accordingly (250). The network computer system 150 responds to the API request with success or failure (260). If a failure occurs, the network computer system 150 can roll back the changes to prevent corruption of the graphic design file. If successful, the network computer system 150 can include identifiers for any newly added variables to the second network service 20.

Once updated, the network computer system 150 synchronizes the updated state of the graphic design file to any affected clients (270). For example, another user in the same organization as the user who edited the design may be viewing the design on their user device, which receives the updated design and makes the appropriate changes to display on the user interface of the device (272).

### Network Computer System

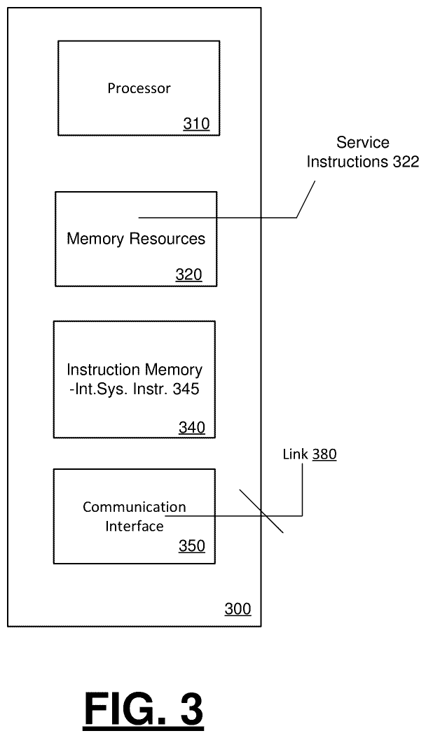

FIG. 3 illustrates a computer system on which one or more embodiments can be implemented. A computer system 300 can be implemented on, for example, a server or combination of servers. For example, the computer system 300 may be implemented as the network computing system 150 of FIG. 1.

In one implementation, the computer system 300 includes processing resources 310, memory resources 320 (e.g., read-only memory (ROM) or random-access memory (RAM)), one or more instruction memory resources 340, and a communication interface 350. The computer system 300 includes at least one processor 310 for processing information stored with the memory resources 320, such as provided by a random-access memory (RAM) or other dynamic storage device, for storing information and instructions which are executable by the processor 310. The memory resources 320 may also be used to store temporary variables or other intermediate information during execution of instructions to be executed by the processor 310.

The communication interface 350 enables the computer system 300 to communicate with one or more user computing devices, over one or more networks (e.g., cellular network) through use of the network link 380 (wireless or a wire). Using the network link 380, the computer system 300 can communicate with one or more computing devices, specialized devices and modules, and/or one or more servers.

In examples, the processor 310 may execute service instructions 322, stored with the memory resources 320, in order to enable the network computing system to implement the network service 172 and operate as the network computing system 170 in examples such as described with FIG. 1A through FIG. 1C.

The computer system 300 may also include additional memory resources (“instruction memory 340”) for storing executable instruction sets (“Int. sys. instr. 345”) which are embedded with webpages and other web resources, to enable user computing devices to implement functionality such as described with the system 100.

As such, examples described herein are related to the use of the computer system 300 for implementing the techniques described herein. According to an aspect, techniques are performed by the computer system 300 in response to the processor 310 executing one or more sequences of one or more instructions contained in the memory 320. Such instructions may be read into the memory 320 from another machine-readable medium. Execution of the sequences of instructions contained in the memory 320 causes the processor 310 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

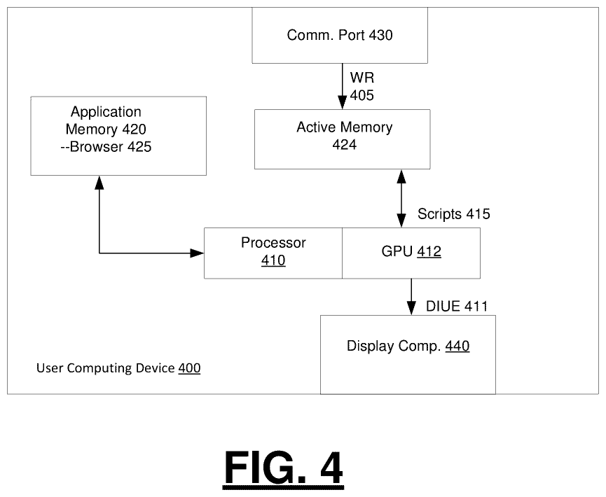

FIG. 4 illustrates a user computing device for use with one or more examples, as described. In examples, a user computing device 400 can correspond to, for example, a workstation, a desktop computer, a laptop or other computer system having graphics processing capabilities that are suitable for enabling renderings of design interfaces and graphic design work. In variations, the user computing device 400 can correspond to a mobile computing device, such as a smartphone, tablet computer, laptop computer, VR or AR headset device, and the like.

In examples, the computing device 400 includes a central or main processor 410, a graphics processing unit 412, memory resources 420, and one or more communication ports 430. The computing device 400 can use the main processor 410 and the memory resources 420 to store and launch a browser 425 or other web-based application. A user can operate the browser 425 to access a network system 150, using the communication port 430, where one or more web pages or other resources 405 associated with the network system 150 can be downloaded. The web resources 405 can be stored in the active memory 424 (cache).

As described by various examples, the processor 410 can detect and execute scripts and other logic which are embedded in the web resource in order to implement the IGDS 100 (see FIG. 1). In some of the examples, some of the scripts 415 which are embedded with the web resources 405 can include GPU accelerated logic that is executed directly by the GPU 412. The main processor 410 and the GPU can combine to render a design interface under edit (“DIUE 411”) on a display component 440. The rendered design interface can include web content from the browser 425, as well as design interface content and functional elements generated by scripts and other logic embedded with the web resource 405. By including scripts 415 that are directly executable on the GPU 412, the logic embedded with the web resource 415 can better execute the IGDS 100, as described with various examples.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computer system comprising:
a memory resource storing instructions; and
one or more processors using the instructions stored in the memory resource to perform operations including:
implementing a single unified application programming interface (API) to remotely add and update variables associated with a graphic design file;
receiving an API request from a programmatic process executed on a remote device, the API request including one or more lists of key/value pairs;
accessing the graphic design file; and
editing the variables in the graphic design file based on the one or more lists of key/value pairs included in the API request.

2. The computer system of claim 1, wherein the API request is used to synchronize at least some of the variables in the graphic design file with a network service on the remote device.

3. The computer system of claim 1, wherein editing the variables in the graphic design file includes: upon determining that a new variable specified in the API request does not exist in the graphic design file, adding the new variable with a new identifier to the graphic design file and providing the new identifier to the remote device in a response to the API request.

4. The computer system of claim 3, wherein adding the new variable includes applying default variable values consistent with a variables table interface.

5. The computer system of claim 1, wherein editing the variables in the graphic design file is treated as an atomic operation such that if there are any validation failures, then the graphic design file remains unchanged.

6. The computer system of claim 1, wherein the API request includes an authentication token for an organization with access to the graphic design file, and accessing the graphic file includes using the authentication token to permit access.

7. The computer system of claim 1, wherein keys in the key/value pairs include one or more of an action, variable identifier, name, collection identifier, or data type.

8. A method being implemented by one or more processors and comprising:
implementing a single unified application programming interface (API) to remotely add and update variables associated with a graphic design file;
receiving an API request from a programmatic process executed on a remote device, the API request including one or more lists of key/value pairs;
accessing the graphic design file; and
editing the variables in the graphic design file based on the one or more lists of key/value pairs included in the API request.

9. The method of claim 8, wherein the API request is used to synchronize at least some of the variables in the graphic design file with a network service on the remote device.

10. The method of claim 8, wherein editing the variables in the graphic design file includes: upon determining that a new variable specified in the API request does not exist in the graphic design file, adding the new variable with a new identifier to the graphic design file and providing the new identifier to the remote device in a response to the API request.

11. The method of claim 10, wherein adding the new variable includes applying default variable values consistent with a variables table interface.

12. The method of claim 8, wherein editing the variables in the graphic design file is treated as an atomic operation such that if there are any validation failures, then the graphic design file remains unchanged.

13. The method of claim 8, wherein the API request includes an authentication token for an organization with access to the graphic design file, and accessing the graphic file includes using the authentication token to permit access.

14. The method of claim 8, wherein keys in the key/value pairs include one or more of an action, variable identifier, name, collection identifier, or data type.

15. A non-transitory computer-readable medium that stores instructions, executable by one or more processors, to cause the one or more processors to perform operations including:
implementing a single unified application programming interface (API) to remotely add and update variables associated with a graphic design file;
receiving an API request from a programmatic process executed on a remote device, the API request including one or more lists of key/value pairs;
accessing the graphic design file; and
editing the variables in the graphic design file based on the one or more lists of key/value pairs included in the API request.

16. The non-transitory computer-readable medium of claim 15, wherein the API request is used to synchronize at least some of the variables in the graphic design file with a network service on the remote device.

17. The non-transitory computer-readable medium of claim 15, wherein editing the variables in the graphic design file includes: upon determining that a new variable specified in the API request does not exist in the graphic design file, adding the new variable with a new identifier to the graphic design file and providing the new identifier to the remote device in a response to the API request.

18. The non-transitory computer-readable medium of claim 16, wherein adding the new variable includes applying default variable values consistent with a variables table interface.

19. The non-transitory computer-readable medium of claim 15, wherein editing the variables in the graphic design file is treated as an atomic operation such that if there are any validation failures, then the graphic design file remains unchanged.

20. The non-transitory computer-readable medium of claim 15, wherein the API request includes an authentication token for an organization with access to the graphic design file, and accessing the graphic file includes using the authentication token to permit access.
